(19) United States
(12) Patent Application Publication
(10) Pub. No.: US 2011/0313855 A1
(43) Pub. Date: Dec. 22, 2011

(54) System, Method and Apparatus for Automated Resource Allocation among Multiple Resource Server Systems

(76) Inventors: Ayyappan Sankaran, San Jose, CA (US); Jayant Kadambi, Mountain View, CA (US); Michael Lu, San Jose, CA (US)

(21) Appl. No.: 12/817,095

(22) Filed: Jun. 16, 2010

(51) Int. Cl. G06Q 30/00; G06F 15/173

(52) U.S. Cl. 705/14.49; 709/226; 705/14.73

(57) ABSTRACT

A system for automated resource allocation includes a client computer provided with a network interface, a plurality of resource server systems each provided with a network interface, and an operation server system provided with a network interface. In an embodiment, set forth by way of example and not limitation, the operation server system can be configured to obtain client parameters from the client computer for a fulfillment campaign, obtain resource parameters from the plurality of resource server systems, obtain operational parameters relevant to the fulfillment campaign, and allocate among the plurality of resource server systems in accordance with at least some of the client parameters, the resource parameters and the operational parameters to implement the fulfillment campaign.

### BACKGROUND

Electronic commerce, often known as “e-commerce”, includes the buying and selling of products or services over electronic systems such as the Internet. The amount of trade conducted electronically has grown immensely with the widespread adoption of Internet technology. One particularly explosive area of growth in e-commerce is in the field of advertising and, in particular, video advertising on the Internet.

Advertising is a common way or seller of goods and/or services to generate sales. In traditional media, such as television and print media, an advertisement may be seen by a wide demographic audience. Generally, only a small percentage of the audience will have any interest in purchasing the goods or services. Also, with traditional media, there is typically a limited supply of space for advertisements. In the art, the amount of resources (e.g., physical space, time, etc.) available for advertising is sometimes referred to as “inventory.”

The inherent nature of the Internet is that it creates ever-increasing amounts of advertising inventory. This is because web technology can generate an advertising message image (called an “impression”) each time a web page is accessed. Since multiple users can access a web page simultaneously, and since the number of Internet users and web pages is constantly increasing, the “inventory” of advertising space on the Internet is almost limitless.

As a result of large surplus of inventory, there is competition by websites (“publishers”) for advertisers and entities that represent advertisers. That is, since many advertisers are represented by ad agencies, ad networks, and/or other entities managing the distribution of advertising (collectively “ad networks”) this competition for advertisers extends to such entities. Since most web publishers offer some form of fee splitting arrangement with ad networks, some of this competition may be reflected by the profit margins they offer to ad networks. Also, different websites cater to different demographics, have different “click-through” rates, etc., all of which can be used to attract the interest of advertisers and ad networks.

Because the parameters associated with websites differ, advertisers will often allocate their campaign budgets among multiple publishers. Traditionally, advertisers make allocations between different publishers in an ad hoc manner such as by manually determining which percentage of their budget should go to any particular publisher. The allocation percentages made by advertisers are often based as much upon intuition as upon a detailed analysis of the different parameters associated with each publisher, which can change dynamically during the course of a campaign. Since there are many parameters associated with each publisher, and since there are many thousands of publishers from which to choose, and because parameters such as click-rates change dynamically, it is very difficult for advertisers to optimally allocate their campaign budgets among multiple publishers.

While the sale and purchasing of advertising (such as video advertising) on the Internet is one example of the problem of automated resource allocation among multiple resource server systems there are many other examples of such a problem. For example, a client, such as a manufacturing company, may desire to purchase a widget from multiple resources (vendors) in order to not be dependent upon any one supplier and to balance various parameters including price, time to delivery, etc. among the various suppliers. Again, allocating the company's budget among the multiple vendors can become a complex, technical problem that is hard to manually optimize.

These and other limitations of the prior art will become apparent to those of skill in the art upon a reading of the following descriptions and a study of the several figures of the drawing.

### SUMMARY

By way of non-limiting example, a system for automated resource allocation includes a client computer provided with a network interface, a plurality of resource server systems each provided with a network interface, and an operation server system provided with a network interface. In an embodiment, set forth by way of example and not limitation, the operation server system can be configured to obtain client parameters from the client computer for a fulfillment campaign, obtain resource parameters from the plurality of resource server systems, obtain operational parameters relevant to the fulfillment campaign, and allocate among the plurality of resource server systems in accordance with at least some of the client parameters, the resource parameters and the operational parameters to implement the fulfillment campaign.

By way of another non-limiting example, an apparatus for automated media allocation includes a computer having a central processing unit, a network interface and computer readable media storing program instructions for the central processing unit. In an embodiment, set forth by way of example and not limitation, the program instructions implement the acts of obtaining advertiser parameters for a web-based advertising campaign from an advertiser, obtaining publisher parameters from a plurality of publishers, and automatically allocating among the plurality of publishers in accordance with at least some of the advertiser parameters and the publisher parameters to implement the web-based advertising campaign.

By way of a yet another non-limiting example, a computer-implemented method for automated media allocation over a global network includes electronically obtaining advertiser parameters for a web-based advertising campaign over a global network, electronically obtaining publisher parameters from a plurality of publishers over the global network, and electronically allocating over the global network among the plurality of publishers in accordance with at least some of the advertiser parameters and the publisher parameters to implement the web-based advertising campaign.

These and other embodiments and other features disclosed herein will become apparent to those of skill in the art upon a reading of the following descriptions and a study of the several figures of the drawing.

### BRIEF DESCRIPTION OF THE DRAWINGS

Several example embodiments will now be described with reference to the drawings, wherein like components are provided with like reference numerals. The example embodiments are intended to illustrate, not limit, concepts disclosed herein. The drawings include the following figures:

FIG. 1 illustrates a system for dynamic resource allocation;

FIG. 2 is a block diagram of an example computer, proxy and/or server which may form a part of the system of FIG. 1;

FIG. 3 is an example screen shot of a user interface to the system of FIG. 1;

FIG. 4 is a flow diagram of an example process for dynamic resource allocation which may be implemented on the system of FIG. 1;

FIG. 5 is a flow diagram of an example process implementing the EXECUTE CAMPAIGN THROUGH COMPLETION operation of FIG. 4;

FIG. 6 is a flow diagram of an example process implementing the DEVELOP INITIAL PARAMETERS operation of FIG. 5;

FIG. 7 is a flow diagram of an example process implementing the CALCULATE TARGET ALLOCATION operation of FIG. 5;

FIG. 8 is a table of an example illustrating the process of FIG. 7;

FIG. 9 is a flow diagram of an example process implementing the IMPLEMENT CAMPAIGN WITH PUBLISHERS operation of FIG. 5;

FIG. 10 is a table of example campaign parameters used to illustrate the process of FIG. 9; and

FIG. 11 is a table illustrating the operation of process of FIG. 9.

### DETAILED DESCRIPTIONS

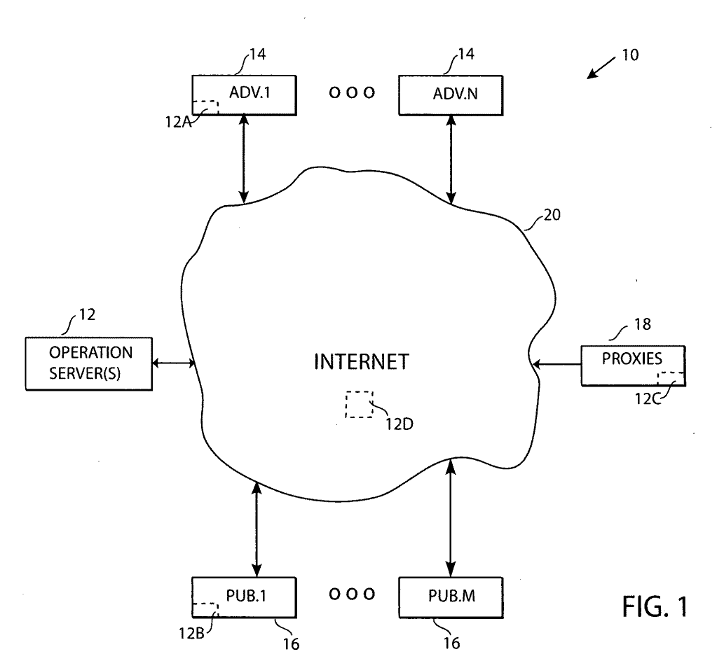

FIG. 1 illustrates a system 10 for automated resource allocation in accordance with a non-limiting example. In this example embodiment, the system 10 includes one or more operation servers 12, one or more advertiser computers 14 and one or more publisher server systems 16. The system at 10 may further include other computers, servers or computerized systems such as proxies 18. In this example, the operation servers 12, advertiser computers 14, publisher server systems 16, and proxies 18 can communicate by a wide area network such as the Internet 20 (also known as a “global network” or a “wide area network” or “WAN” operating with TCP/IP packet protocols).

The operation servers 12 can be implemented as a single server or as a number of real or virtual servers, such as a server farm and/or virtual servers, as will be appreciated by those of skill in the art. Alternatively, the functionality of the operation servers 12 may be implemented elsewhere in the system 10 such as on an advertiser computer 14, as indicated at 12A, on the publisher server system 16, as indicated at 12B, on a proxy 18 as indicated at 12C or as part as cloud computing as indicated at 12D. As will be appreciated by those of skill in the art, the processes of operation servers 12 may be distributed to these systems within system 10.

In an embodiment, the operation servers provide middleman services between the advertisers and the publishers to facilitate the buying and selling of advertisements over the Internet. In other embodiments, the operation server(s) provide middleman and/or facilitation services for client computers and resource server systems to enhance a variety of e-commerce activities.

In the example embodiment of FIG. 1, the system 10 includes a plurality of advertiser computers 14 {ADV. 1, ADV. 2, . . . , ADV. N}. ADV. 1 can be, for example, a manufacturer of soft drinks, ADV. 2 can be a computer manufacturer and ADV. N can be, for example, an accounting firm. Alternatively, an advertiser can be an advertising agency acting as a middleman in the purchase of advertising for a client. While each of the advertising computers 14 may be implemented as a single computer, such as a personal computer or computer workstation, they can also represent other computer configurations, such as a computing cluster on a local area network (LAN).

The publisher server systems 16 can each represent one or more servers, such as a server farm. In the example embodiment of FIG. 1, the system 10 includes a plurality of publisher server systems 16 {PUB. 1, PUB. 2, . . . , PUB. M}. For example, PUB. 1 can be an Internet portal, PUB. 2 can be a search engine, and PUB. M can be a news website. As noted previously, one or more of the publisher server systems 16 can implement some or all of the functionality of operation servers 12.

Proxies 18 can be computers, servers, or clusters of servers which serve as intermediaries or proxies between the operation servers, advertising computers and/or publisher server systems 16. As noted previously, some or all of the functionality of operation servers 12 may be implemented on proxies 18.

It will again be noted that the system for automated resource allocation 10 as shown in FIG. 1 is but one example of such a system. By way of non-limiting example, the advertiser computers 14 can be generalized to be virtually any form of client computer. By way of further non-limiting example, the publisher server systems 16 can be generalized to be virtually any form of resource server systems. It will therefore be appreciated that while certain embodiment as described herein are directed to an e-commerce advertising sale and purchasing that there are other many other embodiments which can be implemented by the system 10 as described herein.

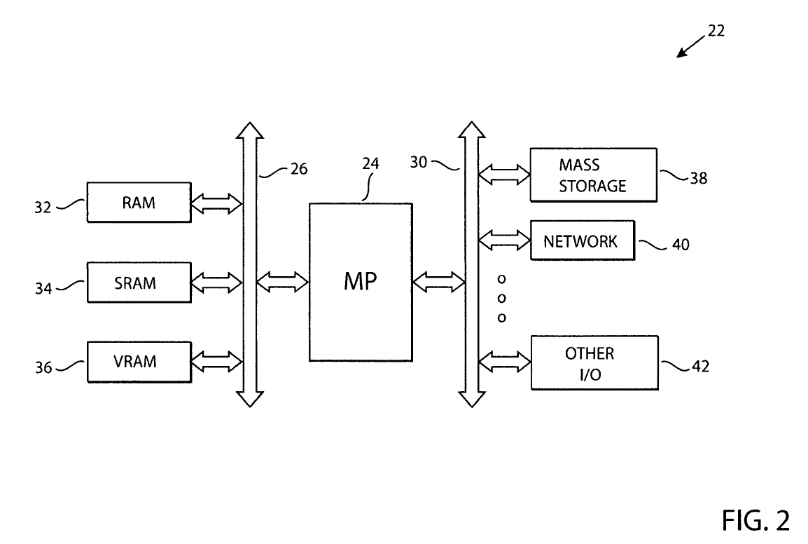

FIG. 2 is a simplified block diagram of a computer and/or server 22 suitable for use in system 10. By way of non-limiting example, computer 22 includes a microprocessor 24 coupled to a memory bus 26 and an input/output (I/O) bus 30. A number of memory and/or other high speed devices may be coupled to memory bus 26 such as the RAM 32, SRAM 34 and VRAM 36. Attached to the I/O bus 30 are various I/O devices such as mass storage 38, network interface 40, and other I/O 42. As will be appreciated by those of skill in the art, there are a number of computer readable media available to the microprocessor 24 such as the RAM 32, SRAM 34, VRAM 36 and mass storage 38. The network interface 40 and other I/O 42 also may include computer readable media such as registers, caches, buffers, etc. Mass storage 38 can be of various types including hard disk drives, optical drives and flash drives, to name a few.

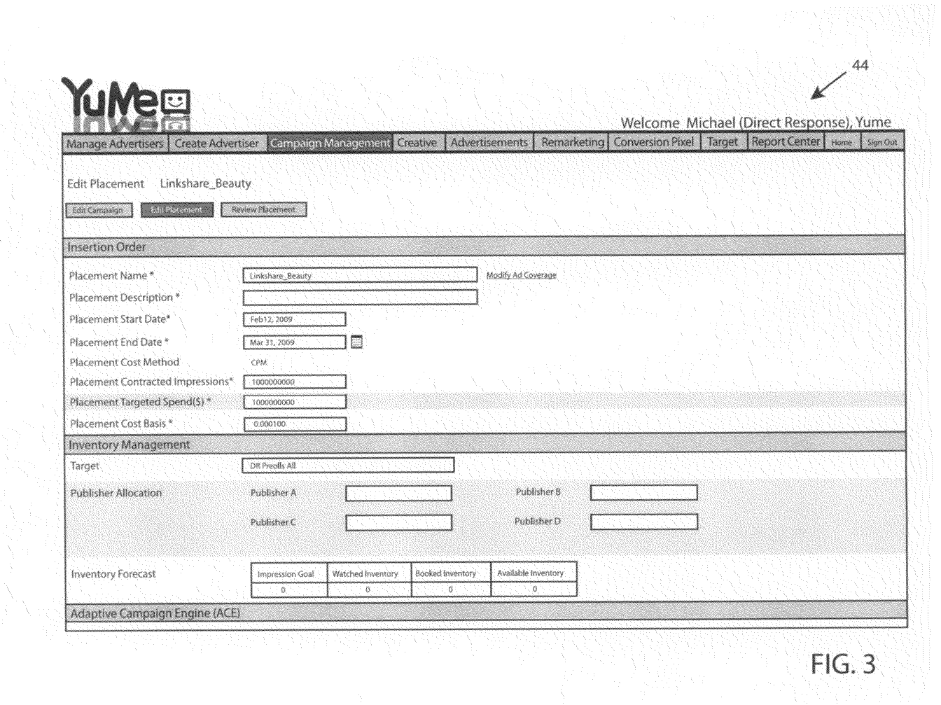

FIG. 3 is a screen shot of a web page, set forth by way of example and not limitation, which may be used as a user interface to the system of FIG. 1. More particularly, web page 44 may be displayed, for example, on the screen of a computer or server of system 10. For example, web page 44 may generated by an operation server 12 and can be displayed a screen of an advertiser computer 14. The advertiser computer 14 can use the web page 44 to, for example, enter advertiser parameters into the system 10. In this example, an advertiser has entered a placement name, a placement start date, a placement end date, a placement cost method, a placement contracted impressions number, a placement targeted spending and a placement cost basis. These can be considered to be advertiser parameters for an advertising campaign. For publisher boxes are shown, namely Publisher A, Publisher B, Publisher C and Publisher D. Ultimately, the allocation of the advertising campaign among the four publishers should add up to 100%.

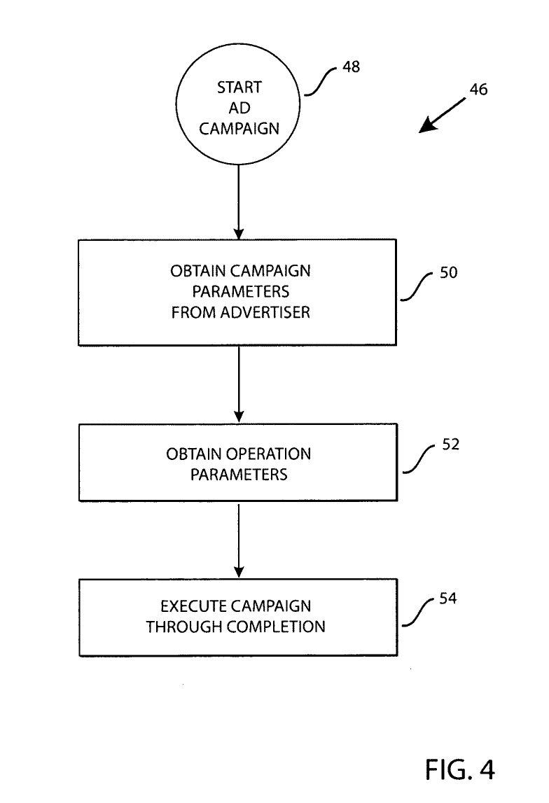

FIG. 4 is a flow diagram of a process 46, set forth by way of example and not limitation, for dynamic resource allocation which may be implemented on the system of FIG. 1. The process 46 begins at 48 with the start of an advertising campaign and continues with an operation 50 for obtaining campaign parameters from an advertiser. The process 46 continues with the operation 52 of obtaining operation parameters and then with an operation 54 where in the advertising campaign is executed through completion.

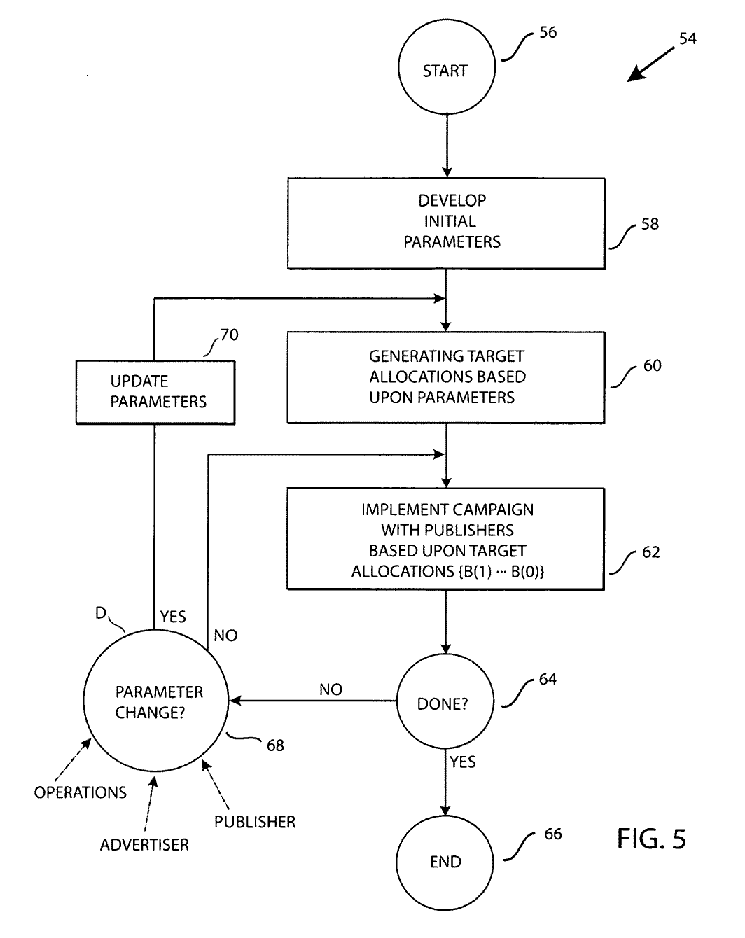

FIG. 5 is a flow diagram of a process 54, set forth by way of example and not limitation, implementing the EXECUTE CAMPAIGN THROUGH COMPLETION operation 54 of FIG. 4. The process 54 begins at 56 and, in an operation 58, develops the initial parameters. Next, operation 60 generates target allocations based upon the initial parameters. This is followed by an operation 62 which implements the campaign with the publishers based upon the target allocations held, for example, by an array {B(1), . . . , B(D)}. A decision operation 64 determines if the campaign has been completed and, if so, the process 54 ends at 66. If the campaign has not been completed as determined by operation 64, a decision operation 68 determines whether there has been a parameter change from, for example, operations, the advertiser or a publisher. If operation 68 determines that there are no parameter changes, process control is returned to operation 62. If there has been at least one parameter change, process control goes to operation 70 to update the parameters and then to operation 60 to generate target allocations based upon the updated parameters. As will be appreciated by those of skill in the art, the new target allocations may be stored for future use or may be implemented immediately. It will also be appreciated by those of skill in the art that the target allocation calculations may be caches so that only those portions of the calculations affected by a parameter change need to be recalculated.

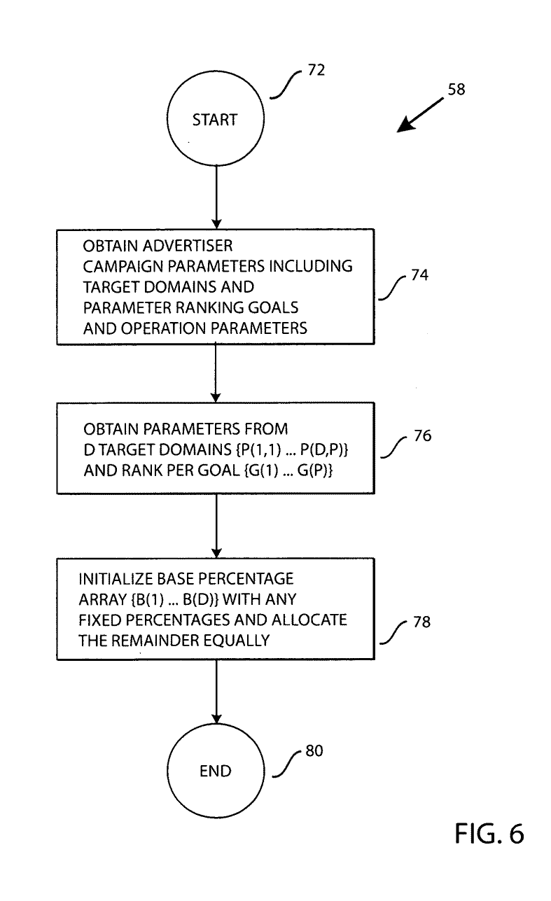

FIG. 6 is a flow diagram, set forth by way of example and not limitation, of a process 58 implementing the DEVELOP INITIAL PARAMETERS operation 58 of FIG. 5. In this figure, the example process 58 begins at 72 and, in an operation 74, advertiser campaign parameters are obtained including target domains, parameter rankings, goals, operation parameters, etc. Next, in an operation 76, P parameters from D target domains (publishers) are obtained as represented by the array {P(1,1), . . . , P(D,P)} as well as the advertiser's ranked goals as represented by the array {G(1), . . . , G(P)}. Finally, in an operation 78, a base percentage array {B(1), . . . , B(D)} is initialized. The initialization of the base percentage array may begin with the allocation of fixed percentages for one or more of the array members (where the percentages can range from 0-100%) from, by way of non-limiting examples, the advertiser, the publisher or operations. If any of the array members are not assigned a fixed percentage, they can, for example, be assigned the remainder of the base percentages, which much total 100%, on an equal basis, by way of non-limiting example. The process 58 ends at 80.

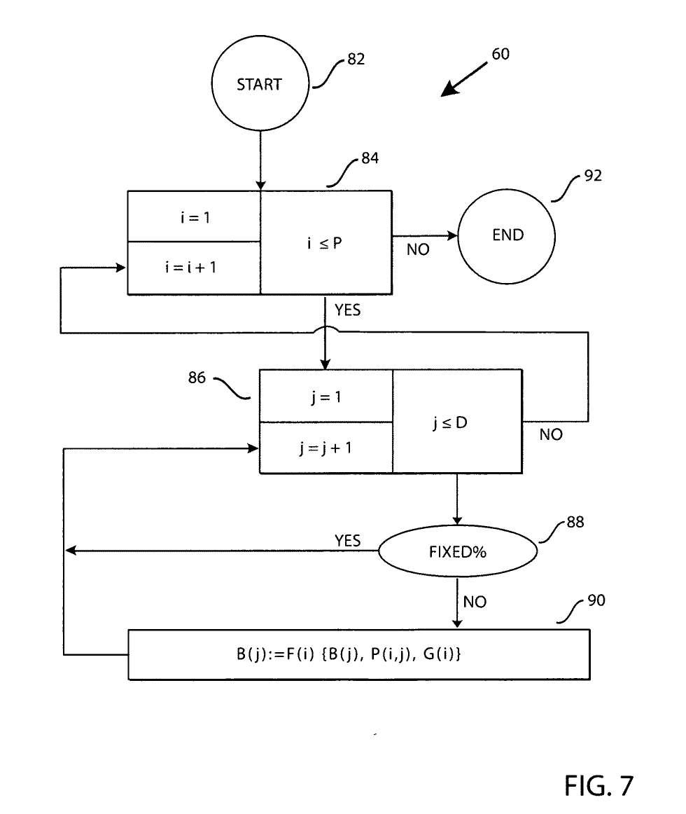

FIG. 7 is a flow diagram illustrating an example process 60 implementing the CALCULATE TARGET ALLOCATION operation 60 of FIG. 5. Process 60 begins at 82 and enters an iterative loop 84. Within iterative loop 84 is a second iterative loop 86. Within the second iterative loop 86 an operation 88 determines whether the parameter P(i,j) is a fixed percentage and, if so, control is returned to the iterative loop 86. If P(i,j) is not a fixed percentage, as determined by operation 88, the base percentage array is updated by the formula:

B(j):=F(i){B(j), P(i,j), G(i)} Equation 1

where the base percentage array {B(1), . . . , B(D)} is updated as a function F(i) of the base percentage array {B(1), . . . , B(D)}, parameter array{P(i,1), . . . , P(i,D)} and goal array G(i). After the updating of the base percentage array in operation 88, process control is returned to iterative loop 86. After D passes through iterative loop 86, process control is returned to iterative loop 84. After P passes through iterative loop 84, the process is completed at 92.

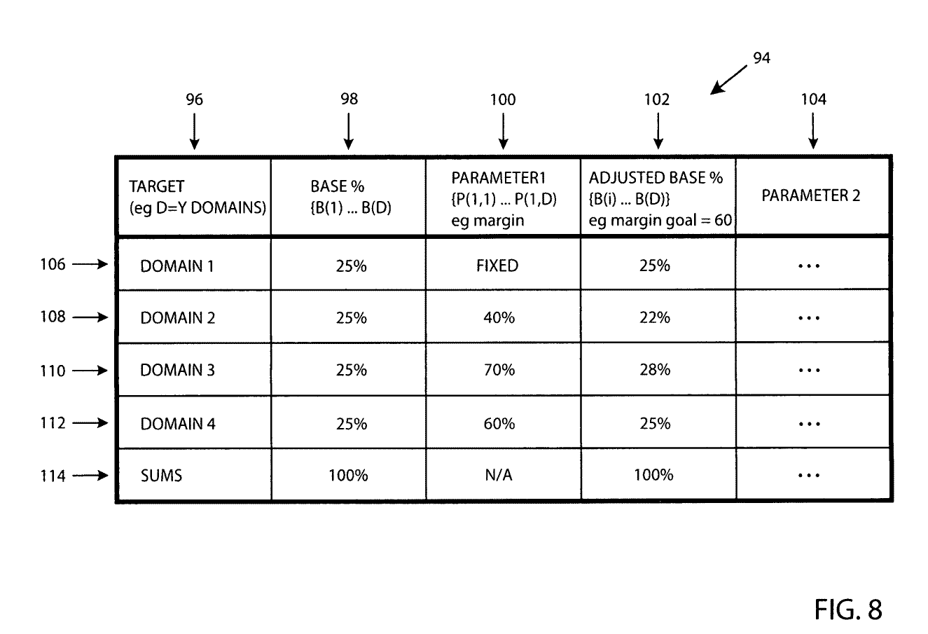

FIG. 8 is a table which illustrates the process of FIG. 7 by way of non-limiting example. In this example, column 96 has the target domains (publishers, in this example), listed as Domain 1 in row 106, Domain 2 in row 108, Domain 3 in row 110 and Domain 4 in row 112. Column 98 is the base percentage array, column is the parameter 1 array, and column 102 has the adjusted base percentage array.

In this example, the base percentage array is being adjusted by the margins offered by the publishers (Domains 1-4). The goal margin for the advertiser in this example is 60%. As seen in column 100, the base percentage for Domain 1 is fixed, and the margin parameter for Domain 2 is 40%, Domain 3 is 70% and Domain 4 is 60%. The function F(i) of Equation 1 produces the adjusted base percentages of column 6 for Domains 2, 3 and 4, while Domain 1 remains fixed at 25%. It should be noted that the base percentage for Domain 2 was adjusted downwardly because the 40% margin offered by Domain 2 was less than the 60% margin goal of the advertiser. The base percentage of Domain 3 was adjusted upwardly because the 70% margin offered by the publisher is greater than the advertiser's margin goal of 60%. In this example, the base percentage of Domain 4 remains the same because the 60% margin offered by the publisher is the same as the advertiser's goal. Other functions F(i) can also be used.

It is desirable to iteratively apply parameters to the base percentage array so that multiple factors can be considered. Other parameters that may be considered to be important by advertisers are inventory, commitments (how many impressions the advertiser is committed to buy), click through rates, view through, stickiness, interaction, acquisitions, key buying activities (KBA), etc. By iteratively applying publisher parameters and advertiser goals to the base percentage array, an optimal allocation of publisher domains can be developed for the advertiser's campaign.

In an embodiment, the advertiser's parameter goals are ranked by importance starting with the least important. This can be accomplished by sorting the goal array G in order of importance, or by creating the array G as a two dimensional array including the goal for the parameter and its rank. By applying successively more important parameters and goals to the base percentage array, the most import goal and parameter will be applied to the base percentage array last, giving it the most influence.

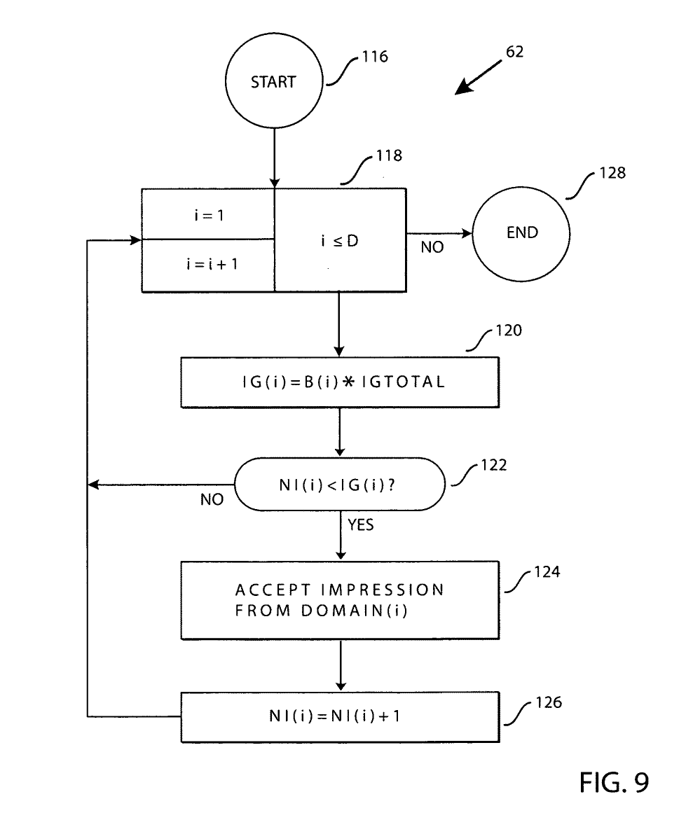

FIG. 9 is a flow diagram of a process 62, set forth by way of example and not limitation, implementing the IMPLEMENT CAMPAIGN WITH PUBLISHERS operation 62 of FIG. 5. The process 62 begins at 116 and enters an iterative loop 118. Next, in an operation 120 and impression goal IG(i) is calculate as the product of the base percentage B(i) and the total impression goal IGTOTAL. In an operation 122 it is determined if the number of impressions NI(i) is less than the impression goal IG(i). If not, process control is returned to iterative loop 118. If the number of impression is less than the impression goal as determined by operation 122, an operation 124 accepts the impression from Domain(i) (L e. the advertiser buys the advertisement from the publisher). Then, in an operation 126 the number of impression array NI(i) is incremented by one, and process control returns to iterative loop 118. After D passes through iterative loop 118, the process 62 ends at 128.

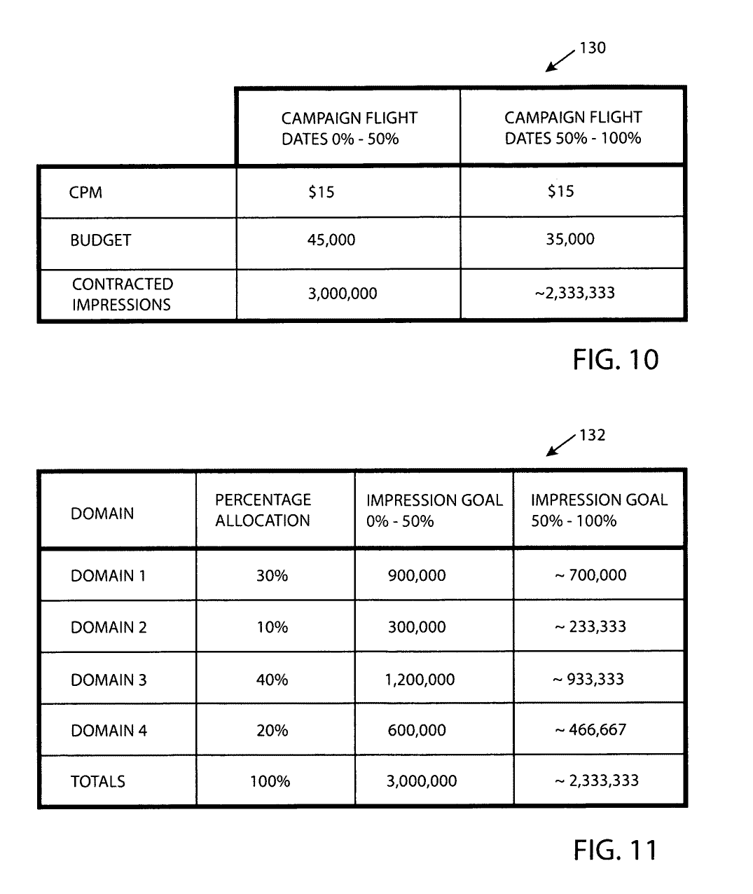

FIG. 10 is a table 130 of example advertiser campaign parameters used to illustrate the process of FIG. 9. In this example, the cost per thousand impressions (CPM) parameter is $15. The budget parameter for the first half of the campaign was $45,000 at which time the budget was reduced to $35,000 for the remainder of the campaign. Therefore, the contracted impressions for the first half of the campaign are 3,000,000 impressions, which were reduced to 2,333,333 impressions for the second half of the campaign.

FIG. 11 is a table 132 illustrating the operation of the process of FIG. 9 by way of example and not limitation when using the campaign parameters of FIG. 10. The percentage allocations (i.e. the base percentage array) for Domains 1, 2, 3 and 4 are 30%, 10%, 40% and 20%, respectively, in this example. This translates to impression goals in the first half of the campaign for Domains 1, 2, 3 and 4 of 900,000, 300,000, 1,200,000 and 600,000 respectively and impression goals in the second half of the campaign for Domains 1, 2, 3 and 4 of 700,00, 233,333, 933,333 and 466,667, respectively, in this example.

A non-limiting example of a video advertising campaign on the Internet is as follows. An ad network, operating, for example, operation server(s) 12, includes as resources a number of Internet publishers 16 who can publish video advertisements. The ad network also has a number of Internet advertisers 14 as clients. One of the advertisers 14, in this example, initiates a video advertising campaign with the ad network by providing a budget and a number of other parameters consistent with its marketing strategies. The advertising campaign may be, for example, a video advertisement for a car which is to be published on various websites by the publishers. The ad network also obtains parameters from its various publishers and may have its own, internally generated parameters. All or some of these parameters, in this example, can be used to determine an optimal allocation of the video advertisement for the car among the various publishers.

It should be noted that the selection of publishers can be enhanced by categorizing the publishers by, for example, content. That is, a “publisher” can be a single legal entity, or a subset of that entity, or a part of a group of entities, by way of several non-limiting examples. For example, a publisher entity may have 1000 publications of which 100 are directed to dramatic content, 100 are directed to comedy, etc. The subset of publications of the publisher entity having a common thematic content may be considered a “publisher.” Furthermore, “publishers” may include a group of publications provided by different agencies which conform to a theme such as, by way of non-limiting examples, drama, sports or entertainment.

It should further be noted that, in some instances, an ad network is, essentially, transparent to advertisers, publishers or both. That is, an ad network may be considered to be a publisher or collection of publishers to an advertiser and/or an ad network may be considered to be an advertiser or collection of advertisers to a publisher.

Although various embodiments have been described using specific terms and devices, such description is for illustrative purposes only. The words used are words of description rather than of limitation. It is to be understood that changes and variations may be made by those of ordinary skill in the art without departing from the spirit or the scope of any embodiments described herein. In addition, it should be understood that aspects of various other embodiments may be interchanged either in whole or in part. It is therefore intended that the claims herein and hereafter presented be interpreted in accordance with their true spirit and scope and without limitation or estoppel.

What is claimed is:

1. A system for automated resource allocation comprising;
a client computer provided with a network interface;
a plurality of resource server systems each provided with a network interface; and
an operation server system provided with a network interface, said operation server system being configured to:
obtain client parameters from said client computer for a fulfillment campaign;
obtain resource parameters from said plurality of resource server systems;
obtain operational parameters relevant to said fulfillment campaign; and
allocate among said plurality of resource server systems in accordance with at least some of said client parameters, said resource parameters and said operational parameters to implement said fulfillment campaign.

2. A system for automated resource allocation as recited in claim 1 wherein said operation server system communicates with said plurality of resource server systems via a global network system.

3. A system for automated resource allocation as recited in claim 1 wherein said operation server system is, at least in part, implemented by at least one of said resource server systems.

4. A system for automated resource allocation as recited in claim 1 wherein said operation server system is, at least in part, implemented by said client computer.

5. A system for automated resource allocation as recited in claim 1 wherein allocating among said plurality of resource server systems includes:
(a) initializing a plurality of current parameters;
(b) generating target allocations based upon said current parameters;
(c) implementing said fulfillment campaign based upon said target allocations;
(d) repeating operations (c) and (d) until completion of fulfillment campaign if no parameter change is detected; and
(e) updating said current parameters and repeating operations (b), (c) and (d) if a parameter change is detected.

6. A system for automated resource allocation as recited in claim 5 wherein operation (a) includes initializing a base percentage array with initial allocations for said plurality of resource server systems.

7. A system for automated resource allocation as recited in claim 6 wherein operation (b) iteratively updates said base percentage array based upon at least one client goal parameter and a corresponding array of resource parameters from said plurality of resource server systems.

8. A system for automated resource allocation as recited in claim 7 wherein said at least one client goal parameter is one of an array of client goal parameters and wherein said array of resource parameters corresponds to said array of client goal parameters.

9. A system for automated resource allocation as recited in claim 8 wherein said array of client goal parameters are ranked by importance.

10. A system for automated resource allocation as recited in claim 9 wherein said client goal parameters are ranked from least important to most important, whereby the base percentage array is iteratively updated with successively more important client goal parameters and wherein said allocation among said plurality of resource server systems is in accordance with the base percentage array determined after fully iterating through said client goal parameters and said corresponding array of resource parameters.

11. An apparatus for automated media allocation comprising;
a computer comprising a central processing unit, a network interface and computer readable media storing program instructions for said central processing unit for implementing the acts of:
obtaining advertiser parameters for a web-based advertising campaign from an advertiser;
obtaining publisher parameters from a plurality of publishers; and
automatically allocating among said plurality of publishers in accordance with at least some of said advertiser parameters and said publisher parameters to implement said web-based advertising campaign.

12. An apparatus for automated media allocation as recited in claim 11 wherein said publisher parameters are obtained over a global network via said network interface.

13. An apparatus for automated media allocation as recited in claim 11 wherein allocating among said plurality of publishers includes:
(a) initializing a plurality of current parameters;
(b) generating target allocations based upon said current parameters;
(c) implementing said web-based advertising campaign based upon said target allocations;
(d) repeating operations (c) and (d) until completion of web-based advertising campaign if no parameter change is detected; and
(e) updating said current parameters and repeating operations (b), (c) and (d) if a parameter change is detected.

14. An apparatus for automated media allocation as recited in claim 13 wherein operation (a) includes initializing a base percentage array with initial allocations for said plurality of publishers.

15. An apparatus for automated media allocation as recited in claim 14 wherein operation (b) iteratively updates said base percentage array based upon at least one advertiser goal parameter and a corresponding array of publisher parameters from said plurality of publishers.

16. An apparatus for automated media allocation as recited in claim 15 wherein said at least one advertiser goal parameter is one of an array of advertiser goal parameters and wherein said array of publisher parameters corresponds to said array of advertiser goal parameters.

17. An apparatus for automated media allocation as recited in claim 16 wherein said array of advertiser goal parameters are ranked by importance.

18. An apparatus for automated media allocation as recited in claim 17 wherein said advertiser goal parameters are ranked from least important to most important, whereby the base percentage array is iteratively updated with successively more important advertiser goal parameters.

19. A computer-implemented method for automated media allocation over a global network comprising:
electronically obtaining advertiser parameters for a web-based advertising campaign over a global network;
electronically obtaining publisher parameters from a plurality of publishers over said global network; and
electronically allocating over said global network among said plurality of publishers in accordance with at least some of said advertiser parameters and said publisher parameters to implement said web-based advertising campaign.

20. A computer-implemented method for automated media allocation over a global network as recited in claim 19 wherein said electronically allocating over said global network comprises:
(a) initializing a plurality of current parameters;
(b) generating target allocations for said plurality of publishers based upon said current parameters;
(c) implementing said web-based advertising campaign based upon said target allocations;
(d) repeating operations (c) and (d) until completion of web-based advertising campaign if no parameter change is detected; and
(e) updating said current parameters and repeating operations (b), (c) and (d) if a parameter change is detected.
